(19) United States
(12) Patent Application Publication
(10) Pub. No.: US 2014/0208214 A1
(43) Pub. Date: Jul. 24, 2014

(54) SYSTEMS AND METHODS FOR MONITORING, VISUALIZING, AND MANAGING PHYSICAL DEVICES AND PHYSICAL DEVICE LOCATIONS

(71) Applicant: Gabriel D. Stern, Austin, TX (US)

(72) Inventor: Gabriel D. Stern, Austin, TX (US)

(21) Appl. No.: 13/748,215

(22) Filed: Jan. 23, 2013

(51) Int. Cl. H04L 12/24

(52) U.S. Cl. CPC H04L 41/22
USPC 715/734

(57) ABSTRACT

In accordance with the present disclosure, systems and methods for monitoring and managing physical devices and physical device locations in a network are described herein. An example method may include generating at a processor of an information handling system a first graphical representation of a first network structure. The first graphical representation may identify the relative physical orientation of a second network structure and a third network structure. The processor may identify an operational condition corresponding to the second network structure. The processor may also generate a first status indicator within the first graphical representation, with the first status indicator graphically identifying the operational condition.

### TECHNICAL FIELD

The present disclosure relates generally to the operation of computer systems and information handling systems, and, more particularly, to systems and methods for monitoring, visualizing, and managing physical devices and physical device locations.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

As networks become more complex, managing the networks and the information handling systems within the networks, including servers, switches, etc., becomes more difficult. Data centers may include hundreds of pieces of computing equipment each with hundreds of operational conditions and management options. Additionally, networks may include multiple data centers spread across wide geographic areas. The total quantity of equipment and geographically diverse data center locations may make central management and remote identification of precise equipment difficult. In existing management operations, the computing equipment may be listed in a chart or table with little easily-accessible context regarding the placement of the equipment within a particular data center or the particular data center in which the equipment is located. This increases the time and expense required in managing operational conditions and connectivity issues across a diverse network. Additionally, securely tracking, updating, and sharing the management information may be difficult.

### SUMMARY

In accordance with the present disclosure, systems and methods for monitoring and managing physical devices and physical device locations in a network are described herein. An example method may include generating at a processor of an information handling system a first graphical representation of a first network structure. The first graphical representation may identify the relative physical orientation of a second network structure and a third network structure. The processor may identify an operational condition corresponding to the second network structure. The processor may also generate a first status indicator within the first graphical representation, with the first status indicator graphically identifying the operational condition.

The system and method disclosed herein is technically advantageous because it allows for network managers to visually manage and view the physical structures within a network. In contrast to typical management schemes, which may map a network according to the connectivity between the network elements, the systems and method described herein may allow a network manager to visually identify errors within the network within the context of the physical locations of the network in which the errors occur. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 shows an example information handling system.

FIG. 2 shows an example network, according to aspects of the present disclosure.

FIG. 3 shows an example network hierarchy, according to aspects of the present invention.

FIG. 4 shows an example network model using the network hierarchy, according to aspects of the present disclosure.

FIGS. 5A-D show example visual representations corresponding to an example network model, according to aspects of the present disclosure.

FIG. 6 shows an example graphical interface, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

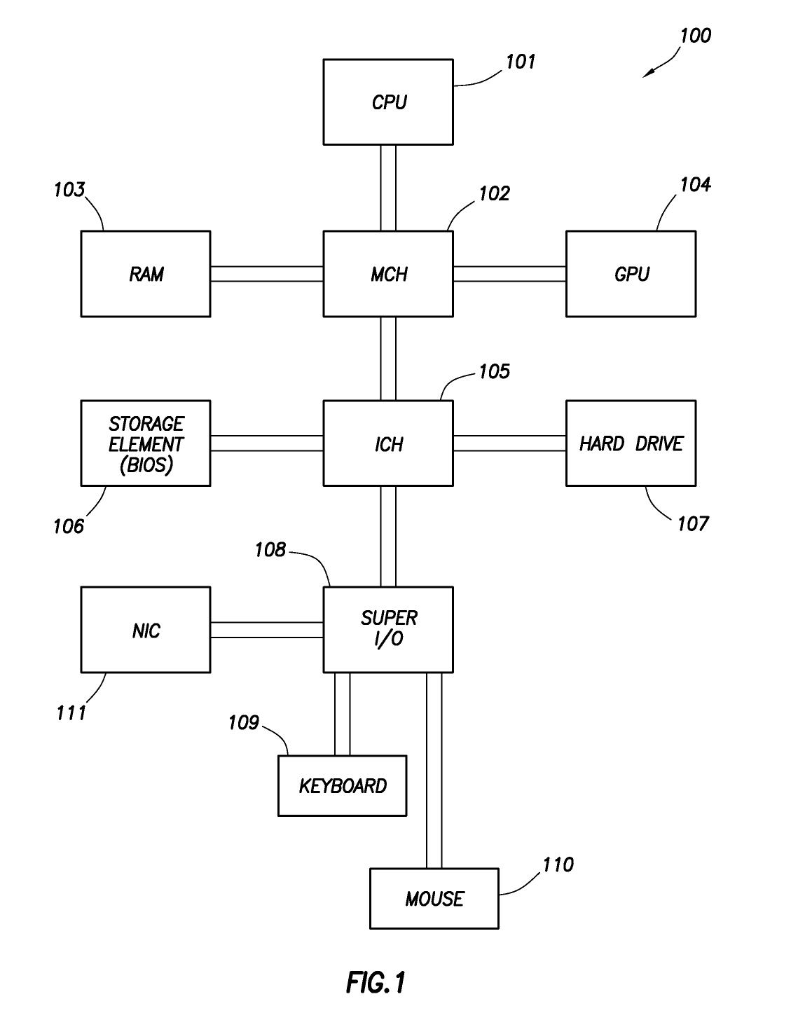

Shown in FIG. 1 is a block diagram of a typical information handling system 100. A processor or CPU 101 of the typical information handling system 100 is communicatively coupled to a memory controller hub or north bridge 102. Memory controller hub 102 may include a memory controller for directing information to or from various system memory components within the information handling system, such as RAM 103, storage element 106, and hard drive 107. The memory controller hub 102 may be coupled to RAM 103 and a graphics processing unit 104. Memory controller hub 102 may also be coupled to an I/O controller hub or south bridge 105. I/O hub 105 is coupled to storage elements of the computer system, including a storage element 106, which may comprise a flash ROM that includes the BIOS of the computer system. I/O hub 105 is also coupled to the hard drive 107 of the computer system. I/O hub 105 may also be coupled to a Super I/O chip 108, which is itself coupled to several of the I/O ports of the computer system, including keyboard 109, mouse 110, and one or more parallel ports. Additionally, the information handling system 100 may include a network interface card (NIC) 111 through which the information handling systems 100 communicates with other information handling systems over a network. The above description of an information handling system should not be seen to limit the applicability of the system and method described below, but is merely offered as an example computing system. Additionally, other information handling systems are possible, including server systems and network systems that may have different components and configurations that information handling system 100.

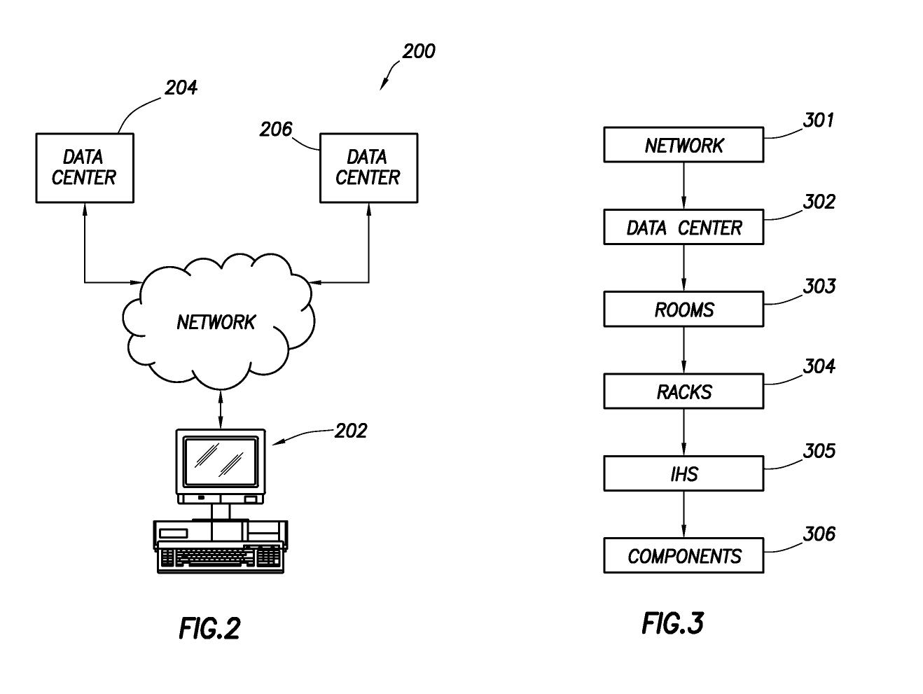

FIG. 2 illustrates an example network 200 comprising a variety of information handling systems in numerous configurations. The network 200 may contain a terminal 202 which communicates with various servers and information handling systems located in data centers 204 and 206. The terminal 202 may be in the same location as the data centers 204 and 206 or may be in a different location, communicating with the data centers 204 and 206 remotely. The data centers 204 and 206, for example, may represent the network infrastructure for a business, supplying computing capabilities and support to hundreds of remotely located terminals. As will be appreciated by one of ordinary skill in the art in view of this disclosure, each of the data centers 204 and 206 may have different physical configurations. For example, the data center 204 may comprise three rooms, each of which contain a different physical configuration of racks, servers, network switches, etc. Typical network management systems may identify and track the connectivity between the various network elements, but do not identify the physical configuration of the data centers, rooms, racks, information handling systems, etc. Additionally, lists of the various computing devices are typically kept in charts or tables, which can be difficult to use and do not provide sufficient data and granularity to effectively identify problematic information handling systems in the context of the information.

According to aspects of the present disclosure, systems and methods for monitoring, visualizing, and managing physical devices and physical device locations are described herein. In certain embodiments, the systems and methods may utilize a network hierarchy that accounts for the physical configuration and orientation of network structures within the various hierarchy levels, including the physical locations of the data centers, the positioning of racks within a data center, the positioning of components within the racks, etc. In certain embodiments, a network model may be built using the hierarchy, with each of the various nodes of the network model being represented by a separate graphical representation of the physical configuration of the corresponding physical structure. Additionally, in certain embodiments, the visual models may be integrated into a graphical display overlaid with data center and information handling system specific error or operation conditions and management information that increase the efficiency of diagnosing and addressing problems within the network, as will be described below. The operational conditions may at least one of a power condition, a thermal condition, a software condition, and a global hardware health condition.

FIG. 3 shows an example network hierarchy 300, according to aspects of the present disclosure. The network hierarchy 300 is not mean to limit this disclosure, and other network hierarchies that utilize none, some, or all of the hierarchy levels discussed below are within the scope of this disclosure. In contrast to typical network hierarchies, which, for example, may characterize a network according to device connectivity, the network hierarchy 300 may divide a network into layers that correspond to its physical network structures such that the hierarchy can be used to identify the physical orientation of the network structures relative to one another. The highest level of the hierarchy may be the network level 301, which generally encompasses all of the network structures within the network. The next level of the hierarchy may comprise data center level 302, which may be the largest physical network structure located within a network. The hierarchy may continue with each subsequent level representing the largest physical network structure within the network structure at the next highest hierarchy level. For example, data center level 302 may be followed by a room level 303, as the rooms of a data center may be the largest physical network structure within a data center. Additionally, room level 303 may be followed by a rack level 304, rack level 304 may be followed by an IHS level 305, and IHS level 305 may be followed by component level 306. In certain embodiments, levels of the hierarchy, such as the IHS level 305 and the component level 206, may represent elements such as servers, converged devices, and modular chassis. In certain embodiments, the hierarchy levels may be variable and may generally correspond to data structures that may be used within a network model discussed below. Moreover, new data structures may be created for other physical layers as needed.

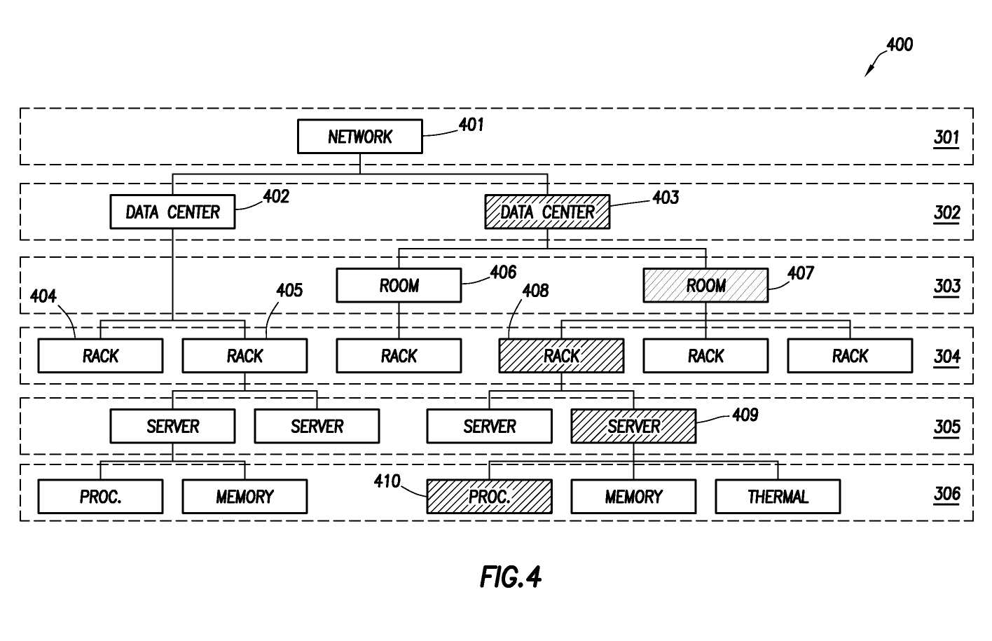

FIG. 4 illustrates an example network model 400 arranged within the hierarchy levels 301-306 described above with respect to FIG. 3. In certain embodiments, the network model 400 may be built with linked data structures or nodes, with the data structures/nodes at each hierarchy level containing similar structure and information, and represented with a similar graphical representation, as will be described below. Each node may correspond to a physical network structure, and may be populated with information regarding the physical structure and the orientation of the smaller physical structures located within. The physical network structure may include, for example, data centers, rooms, racks, server, components, etc.

In the embodiment shown, the network node 401 may contain information regarding the network generally, and may contain information regarding the physical locations of the data centers represented by data center nodes 402 and 403. In certain embodiments, the network node 401 may be linked to data center nodes 402 and 403. Data center node 403 may represent an actual data center, may contain information regarding the physical orientation of the rooms within the actual data center (represented by room nodes 406 and 407), and may contain links to room nodes 406 and 407. Data center node 402 may correspond to another actual data center that does not contain rooms, meaning the data center node 402 may contain information regarding the physical orientation of racks (represented by rack nodes 404 and 405) located within the data center, as well as contain links to rack nodes 404 and 405. In certain embodiments, a given node is not limited to the type of data structure or node to which is can be linked. For example, a data center node may be linked directly to a server node.

In certain embodiments, some or all of the physical network structures represented by the nodes in the model 400 may have corresponding operational conditions. For example, a data center represented by data center node 403 may have structural power requirements and a failure of structural power, or a drop below a certain threshold, may trigger an error notification. This notification may be logged within the data center node 403, and according to aspects of the present disclosure, may also be indicated or tracked within each higher node to which the data center node 403 is directly or indirectly linked. For example, the processor represented by processor node 410 may have experienced a particular error, which may be logged in processor node 410 (indicated by the shading). This operational condition may also be indicated in the node 409 for the server in which the processor is a physically located; in the node 408 for the rack in which the server is located; in the node 407 for the room in which the rack is located; etc. In certain embodiments, the operational conditions may be tracked and logged within separate data structures, but may still overlay the graphical representations of the physical structures of the network. As will be described below, tracking the operational conditions in this manner may allow the operational conditions as well as other management information to be incorporated into graphical representations that may allow a network manager to visually identify physical components at each hierarchy level that have either directly experienced an operational condition, or which include a physical device at a lower hierarchy level that have experienced an operational condition. One example may be out of date software, which may allow a network manager to identify a group of servers with out-of-date software and update the software in bulk.

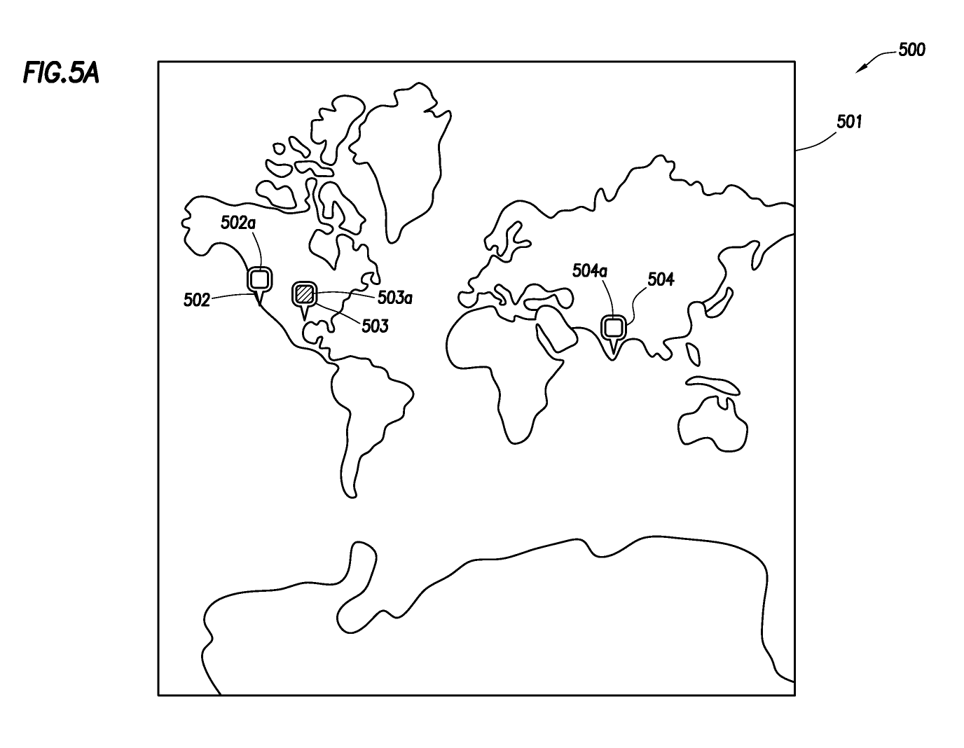

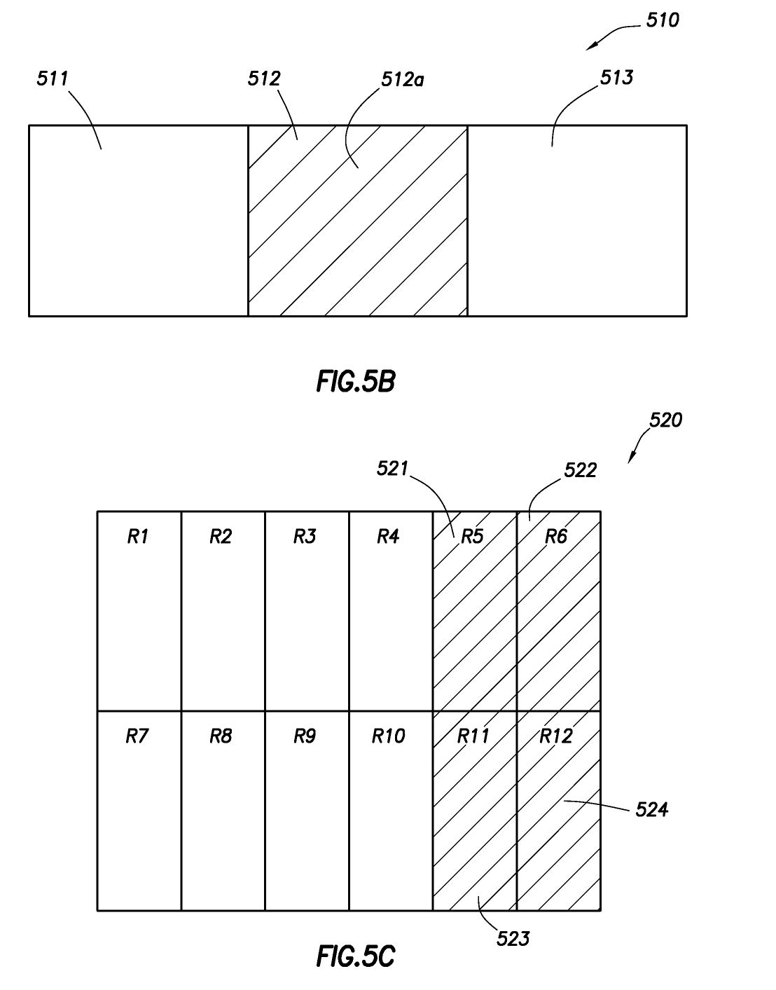

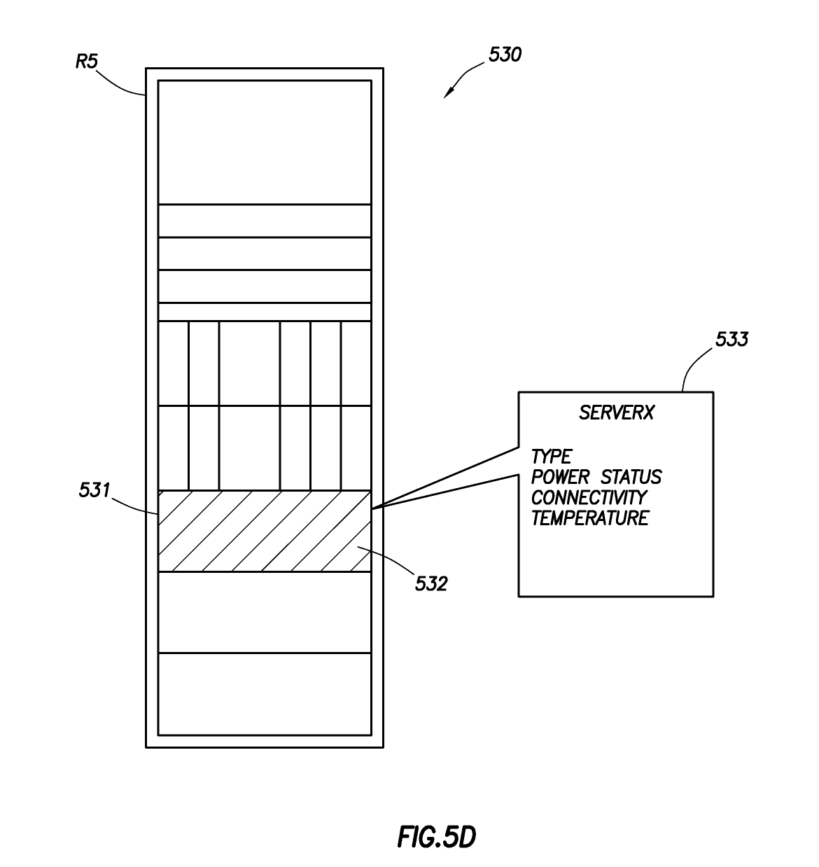

FIGS. 5A-D illustrate example graphical representations that include operational condition overlay, according to aspects of the present disclosure. Each of the nodes/hierarchy levels may have a corresponding graphical representation that visually identifies the physical configuration of the network structure represented by the node. Additionally, each of the graphical representations may be included in a database such that the graphical representations for particular network elements may be selected when a given network is being modeled. For example, a database may have a pre-built graphical representation of a rack as well as graphical representations for different models of servers, switches, etc. that may be installed within a rack. For example, a network administrator who is modeling the network may identify a device from its model number to derive its graphical representation, its device type, and the number of slots it will occupy in a rack.

According to aspects of the present disclosure, the graphical representation of a first physical network structure may visually indicate the orientation of smaller network structure located within the first physical network structure. FIG. 5A, for example, may comprise a graphical representation 500 of a network, which may be represented by a network node 401 at the hierarchy level 301. As can be seen, the graphical representation may comprise a map 501, which may indicate the relative geographic orientations of each of the data centers 502, 503, and 504. The data centers 502, 503, and 504 may be the largest physical network structure included within the network, according to hierarchy 300. The map 501 may be from a typical internet based map program, such as Google Maps, that may indicate the physical locations of the data centers 502, 503, and 504 based on the location information stored within the corresponding data structures.

As can be seen, status indicators 502a, 503a, and 504a may overlay map 501, with the status indicators corresponding to data centers 502, 503, and 504, respectively. The status indicators may indicate an operational condition at the corresponding data center, or at a network structure within the corresponding data center, such as a room, a rack, an IHS, etc. In certain embodiments, the status indicators may be based on the operational condition tracking described above, and may be either updated in real time, or updated according to a polling interval in which the physical structures are queried regarding operational conditions. Additionally, the status indicators may have different configurations, such as color, shading, etc., depending on the type of error. For example, a thermal operational condition may have a first color, while a connectivity issue may have a second color and out-of-date software may have a third color.

FIG. 5B may comprise a graphical representation 510 of the data center 503 at the hierarchy level 302. As can be seen, the graphical representation 510 of the data center 503 may indicate the physical orientation and relationship between the rooms 511-513, the next highest hierarchy level within the data center 503. In certain embodiments, the orientation of the rooms 511-513 may be mapped to the floor plan of the actual data center, such as in an overhead view. In certain embodiments, the graphical representation 511 may include identifiers, such as names, for each room. As can be seen, the graphical representation 510 may also include a status indicator 512a, in this case shading within the structure corresponding to room 512. Status indicator 512a may correspond to the status indicator 503a from FIG. 5A.

FIG. 5C may comprise a graphical representation 520 of the room 512 at the hierarchy level 303. As can be seen, the graphical representation 520 of the room 512 may indicate the physical orientation and relationship between racks R1-R12 within the room 512, with racks being in the next highest hierarchy level. In certain embodiments, the relative orientation of the R1-R12 may be shown within the graphical representation 520. As can be seen, the graphical representation 520 may also include a status indicators 521-524, in this case shading within the structures corresponding racks R5, R6, R11, and R12. The status indicators 521-524 may show, for example, that similar errors are occurring in multiple racks that are proximate to one another. This may allow a network manager to conclude, for example, that a cooling assembly associated with racks R5, R6, R11, and R12 may be faulty. Status indicator 521-524 may correspond to the status indicator 512a from FIG. 5B.

FIG. 5D may comprise a graphical representation 530 of the rack R5 at the hierarchy level 304. As can be seen, the graphical representation 530 of the rack R5 may indicate the physical orientation and relationship between the IHSs that populate the rack R5. Specifically, the graphical representation 530 may correspond to the actual physical implementation of R5, including the precise placement of the various IHSs, with scaled sizes and orientations. As described above, the IHSs may comprise servers, storage devices, switches, etc. In certain embodiments, status indicators may be overlaid on the graphical representation 530. As can be seen, the status indicator 532 may indicate an operational condition within server 531 positioned within rack R5. Status indicator 532 may correspond to the status indicator 521 from FIG. 5C. In certain embodiments, graphical representation 530 may also include information regarding the operational conditions within the servers 531, shown in dialogue box 533. In certain other embodiments, the server 531 may have a corresponding graphical representation that can be viewed and that may indicate in which component of the server 531 the operational condition is occurring.

In certain embodiments, each of the above graphical representations may be generated to match the actual physical configurations of various network components and structures. The graphical representations may include templates, in the case of the racks and server systems, or may be built to match the physical layout of actual structures, such as the rooms of a data center. In certain embodiments, the graphical representations may be built to match an existing network, where the network devices are discovered and listed, and the graphical representations built from the top down. For example, the location of a data center may be stored in a data structure, and the floor plan of the data center, including the location of the rooms, may be imported or built within a graphical tool. Each of the rooms may then be “populated” with racks, and the racks populated with graphical representations of the actual, discovered network elements, according to the actual placement of the racks within the rooms, and the network elements within the racks. Likewise, the graphical representations may be updated as the network configuration changes. For example, if more racks and servers are added to a room in an existing data center, or an additional data center is added to the network, the corresponding graphical representations may either be updated or created as necessary.

In certain embodiments, a software environment may aide in populating the hierarchy structure with network elements. For example, rather than a network administrator having to build graphical representations for different network devices when building a network model, pre-configured graphical representations for particular devices may be stored within a database. The graphical representations may correspond to a model number of the device and may accurately reflect the physical size of the device relative to the graphical representations of other network elements. Each of the devices discovered within a network may correspond to a data set within a database, the data set including the graphical representation, size constraints, and other relevant information. A network administrator modeling a network may determine a model number for a server or other device and select the graphical representation corresponding to that particular model number. The graphical representation may accurately represent the dimensions of the server, including the slot size of the server, relative to the rack in which it is installed. Accordingly, the network administrator may simply “drag-and-drop” the graphical representation for the server into the graphical representation of the rack, without having to build the graphical representation of the server, or provide other information regarding to server. This may reduce the time required to build a network model.

In certain other embodiments, the graphical representations above may be used as design tools. In such instances, the data structures/graphical representations for the various physical element and structures may include physical and capacity limitations. A network manager may then “build” the additional network elements within the graphical representation to test the network element against the physical and capacity requirements of a given physical element or structure. For example, if a defined amount of additional capacity needs to be added to a data center, or a room needs to be redesigned to increase computational capacity, a network manager may “build” the additional equipment, or rearrange the equipment, with the graphical representation of the room. A network manager may then be able to validate the additional equipment or rearranged equipment with the graphical representation.

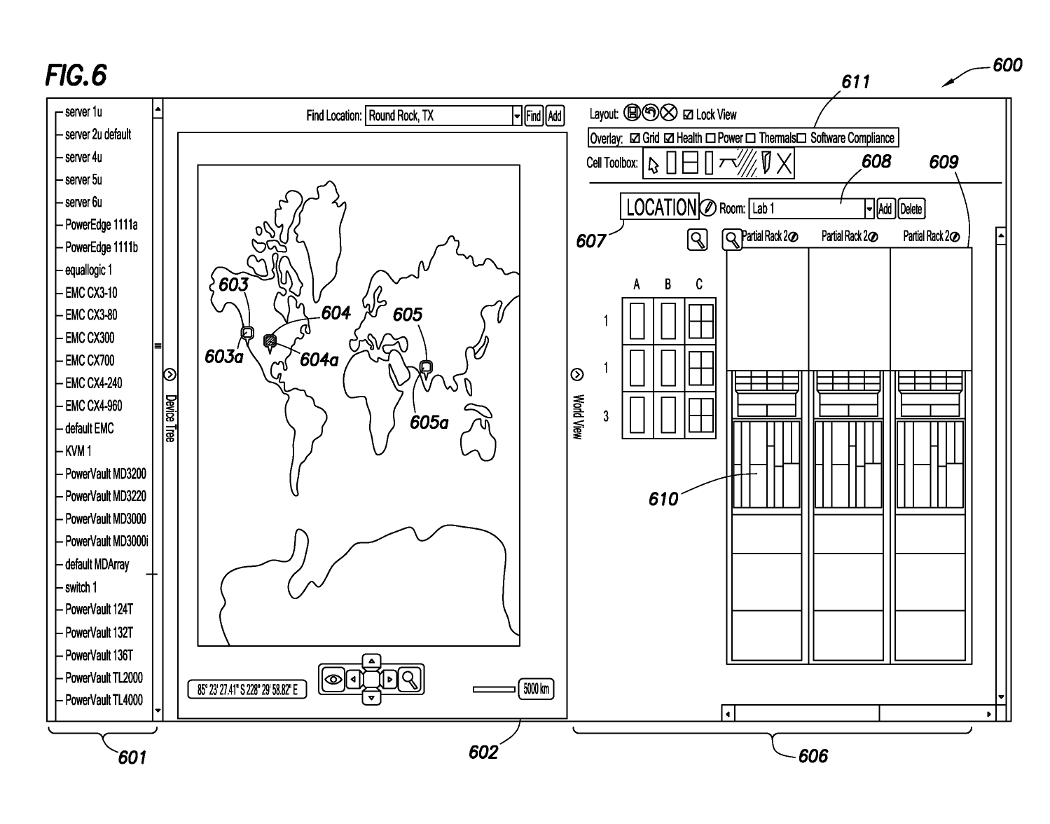

FIG. 6 shows an example graphical interface 600 that may incorporate various graphical representations of the network, and may allow a network manager to manage the network, or design elements of the network. Notably, the interface may allow a user to move between the various graphical representations of a network model similar to the one described above with respect to FIG. 4. In certain embodiments, the graphical interface 600 may be a web based interface that is generated using one of a variety of programming languages well known in the art. The graphical interface 600 may be stored and run on a terminal connected to a network, and may be used as part of a network management or design process that will be described below. The specific layout of the interface shown in FIG. 6 is not meant to be limiting and may include additional elements or fewer elements than shown, and also may be reformatted in any of a variety of configurations.

In certain embodiments, the graphical interface 600 may include a list 601 of some or all of the information handling systems and computing systems within a network. As described above, this list may be populated during a discovery process which a management computer or a server within the network triggers, and in which all of the network connected devices within the network infrastructure are identified and cataloged. Each of the information handling systems, for example, may comprise a unique set of operational conditions that may also be catalogued, such that the interface may identify system specific errors, as described above.

In certain embodiments, the graphical interface 600 may include a network level graphical representation, such as map 602, that may indicate the geographic locations of data centers. The map 602 may be the same as or similar to the map described above with respect to FIG. 5A. The interface 600 may allow a user to zoom into the map to identify the precise location of a given data center, which may be plotted on the map, for example, according to its physical address. In the embodiment shown, the map 602 identifies three data centers 603, 604, and 605 that are marked on the map with corresponding status indicators 603a, 604a, and 605a. As described above, the status indicators 603a, 604a, and 605a may indicate that there is an operational condition associated with the corresponding data center, or it may be overlaid with other management data, as will be described below.

A network manager using the interface 600, for example, may see a status indicator 604a that indicates an operational condition within the data center 604, and select the data center 604 either by clicking on the indicator with a mouse or by selecting from a drop-down box (not shown). A graphical representation of the data center 604 (not shown), similar FIG. 5B, may then be shown in pane 606, and may indicate in which of the rooms the error has occurred. In the embodiment shown, the currently selected data center is indicated at location 607, and a drop-down box 608 may allow the manager to select a particular room of the data center 604. Pane 606 shows a graphical representation 609 at the rack level, indicating the locations of various IHSs and computing devices within the racks. As described above, a status indicator 610 may overlay the graphical representation to identify a particular server that may have an operational condition.

As will be appreciated by one of ordinary skill in the art in view of this disclosure, the graphical interface 600 may allow a network manager to efficiently identify the server experiencing an error along with the precise physical location of the server within the network, the data center, the rooms, and the rack. For example, a network manager may view the network level map 602, and identify when an operational condition has occurred based on when and if a status indicator changes. The network manager may then select the data center with the error, and then continue to progress through the graphical representations, according to the status indicator at each level, until the physical structure with the error is identified. The network manager may then follow up with particular instructions to workers on site, or manage the problem remotely.

Additionally, the graphical interface 600 may be incorporated into a remotely accessible program that a user may log into. An access list may be defined which may limit the users who may view the information. For example, a site manager at a data center may be provided access to the management information. In certain embodiments, the access may be to the entire management data set, or to a limited set, such as the management information corresponding to the data center where the site manager is located.

In certain embodiments, other management information may be indicated/overlaid within the graphical representations. As can be seen in FIG. 6, an overlay control 611 may allow a user of the interface 600 to select which management information to overlay. This may include but is not limited to operational conditions, including power and thermal issues, connectivity issues, hardware health issues, software compliance, etc. Various data regarding the physical devices may be tracked, for example, within the data structures described above. If a software compliance overlay is used, for example, the software versions for the various information handling systems may be checked and an error may be generated if the software version is not up to date. This error may by visually indicated by a status indicator, so that a network manager may identify which data centers, rooms, racks, and servers contain software that needs to be updated.

In certain embodiments, a user may launch a remote network action within the graphical interface 600. The network action may be running a diagnostic tool, updating software, controlling hardware, controlling datacenter infrastructure, etc. For example, a user may be able to execute a remote action or task on the system, and specifically from a graphical representation within the graphical interface 600. The graphical interface 600 may be incorporated into a management program that may communicate with the network elements using various network protocols that would be appreciated by one of ordinary skill in the art in view of this disclosure. The user may, for example, remotely trigger a software update by selecting a graphical representation within the interface 600. The action may be in response to an operational condition indicating out-of-date software or may be proactive. Additionally, the action may be directed at a first network element corresponding to the graphical representation, or to all of the network elements included within the first network element. For example, a software update may be implemented to all servers within a rack by directing a software update action at the rack through the graphical representation of the rack.

In accordance with the present disclosure, systems and methods for monitoring and managing physical devices and physical device locations in a network may utilize some or all of the above hierarchy, model, graphical representations, and graphical interface. An example method may include generating at a processor of an information handling system a first graphical representation of a first network structure. The first graphical representation may comprise, for example, a map, a data center, a room, a rack, etc. The first graphical representation may identify the relative physical orientation of a second network structure and a third network structure. For example, if the first graphical representation comprises a map, the second network structure may comprise a first data center and the third network structure may comprise a second data center. The geographic positions of the data centers may be shown on the map.

The method may also include identifying an operational condition corresponding to the second network structure. The operational condition may comprise one of the operational conditions described above, or other management information that would be appreciated by one of ordinary skill in view of this disclosure. The operational condition may correspond directly to the second network structure, or may represent an operation condition of an additional network structure that is included within the second network structure. The method may include generating a first status indicator within the first graphical representation. For example, the status indicator may be shown on a map, and may graphically identify the data center and the operational condition corresponding to the data center.

In certain embodiments, the method may further include generating at the processor a second graphical representation of the second network structure, wherein the second graphical representation identifies the relative physical orientation of a fourth network structure and a fifth network structure. For example, the second graphical representation of the second network structure may correspond to a graphical representation of a data center that indicates the relative physical orientation of rooms within the data center. Likewise, the second graphical representation may correspond to a room of a data center and may indicate the relative physical orientation of racks within the data center. In certain embodiment, the operational condition may correspond to the fourth network structure, indirectly corresponding to the second network structure because the fourth network structure is included within the second network structure. In such cases, the method may further comprise generating at the processor a second status indicator within the second graphical representation, wherein the second status indicator graphically identifies the operational condition and identifies the fourth network structure as the source of the operation condition.

In certain embodiments, the steps described above may be included as a set of instructions within a non-transitory computer readable medium. When a processor executes the steps, it may perform the same or similar steps to those described above. In certain embodiments, the non-transitory computer readable medium may be incorporated into an information handling system, whose processor may execute the instructions and perform the steps.

As will be appreciated by one of ordinary skill in view of this disclosure, the systems and methods described herein may provide for increased network control and management. For example, the use of graphical representations, including geospatial maps, may increase the visibility of a large, geographically diverse network. Likewise, chaining the network elements within a loose hierarchy may allow for a network administrator to “drill-down” through the graphical representations, in some instances to the device level. Additionally, dynamically rendering and updating the graphical representations with management information may increase the speed within which problems are identified and addressed.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Although the present disclosure has been described in detail, it should be understood that various changes, substitutions, and alterations can be made hereto without departing from the spirit and the scope of the invention as defined by the appended claims. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A method for monitoring and managing physical devices and physical device locations in a network, comprising:
generating at a processor of an information handling system a first graphical representation of a first network structure, wherein the first graphical representation identifies the relative physical orientation of a second network structure and a third network structure;
identifying at the processor an operational condition corresponding to the second network structure; and
generating at the processor a first status indicator within the first graphical representation, wherein the first status indicator graphically identifies the operational condition.

2. The method of claim 1, wherein:
the operational condition comprises at least one of a power condition, a thermal condition, a software condition, and a global hardware health condition; and
the network structures comprise at least one of data centers, room, racks, and servers.

3. The method of claim 1, further comprising, generating at the processor a second graphical representation of the second network structure, wherein the second graphical representation identifies the relative physical orientation of a fourth network structure and a fifth network structure.

4. The method of claim 3, wherein the operational condition corresponding to the second network structure further corresponds to the fourth network structure;

5. The method of claim 4, further comprising generating at the processor a second status indicator within the second graphical representation, wherein the second status indicator graphically identifies the operational condition.

6. The method of claim 3, wherein:
the first graphical representation comprises a map;
the second network structure comprises a first data center;
the third network structure comprises a second data center; and
the relative physical orientation of the second network structure and the third network structure comprises a geographic location of the first data center and a geographic location of the second data center.

7. The method of claim 1, wherein
the first network structure comprises a device with a corresponding model number;
generating the first graphical representation of the first network structure comprises retrieving data from a database using the corresponding model number; and
the data includes a slot size of the device.

8. The method of claim 3, wherein:
the first network structure comprises a room within a data center;
the second network structure comprises a first rack within the room;
the third network structure comprises a second rack within the room;
the second graphical representation comprises a graphical representation of the first rack
the fourth network structure comprises a first server installed within the first rack; and
the fifth network structure comprises a second server installed within the first rack.

9. The method of claim 1, further comprising initiating a network action from at least one of the graphical representations.

10. A non-transitory, computer readable medium containing a set of instructions that, when executed by a processor of an information handling system, cause the processor to:
generate a first graphical representation of a first network structure, wherein the first graphical representation identifies the relative physical orientation of a second network structure and a third network structure;
identify an operational condition corresponding to the second network structure; and
generate a first status indicator within the first graphical representation, wherein the first status indicator graphically identifies the operational condition.

11. The non-transitory, computer readable medium of claim 10, wherein:
the operational condition comprises at least one of a power condition, a thermal condition, a software condition, and a global hardware health condition; and
the network structures comprise at least one of data centers, room, racks, and servers.

12. The non-transitory, computer readable medium of claim 10, wherein the set of instructions, when executed by the processor, further cause the processor to generate at the processor a second graphical representation of the second network structure, wherein the second graphical representation identifies the relative physical orientation of a fourth network structure and a fifth network structure.

13. The non-transitory, computer readable medium of claim 12, wherein the operational condition corresponding to the second network structure further corresponds to the fourth network structure;

14. The non-transitory, computer readable medium of claim 13, wherein the set of instructions, when executed by the processor, further cause the processor to generate at the processor a second status indicator within the second graphical representation, wherein the second status indicator graphically identifies the operational condition.

15. The non-transitory, computer readable medium of claim 14, wherein:
the first graphical representation comprises a map;
the second network structure comprises a first data center;
the third network structure comprises a second data center; and
the relative physical orientation of the second network structure and the third network structure comprises a geographic location of the first data center and a geographic location of the second data center.

16. The non-transitory, computer readable medium of claim 15, wherein:
the fourth network structure comprises a first room of the first data center; and
the fifth network structure comprises a second room of the first data center.

17. The non-transitory, computer readable medium of claim 12, wherein:
the first network structure comprises a room within a data center;
the second network structure comprises a first rack within the room;
the third network structure comprises a second rack within the room;
the second graphical representation comprises a graphical representation of the first rack
the fourth network structure comprises a first server installed within the first rack; and
the fifth network structure comprises a second server installed within the first rack.

18. The non-transitory, computer readable medium of claim 10, wherein the set of instructions, when executed by the processor, further cause the processor to initiate a network action from at least one of the graphical representations.

19. An information handling system, comprising:
a processor;
memory coupled to the processor, wherein the memory contains a set of instructions that, when executed by the processor, cause the processor to:
generate a first graphical representation of a first network structure, wherein the first graphical representation identifies the relative physical orientation of a second network structure and a third network structure;
generate at the processor a second graphical representation of the second network structure, wherein the second graphical representation identifies the relative physical orientation of a fourth network structure and a fifth network structure;
identify an operational condition corresponding to the fourth network structure; and
generate a first status indicator within the first graphical representation and a second status indicator within the second graphical representation, wherein the first status indicator and the second status indicator correspond to the operational condition.

20. The information handling system of claim 19, wherein:
the first graphical representation comprises a map;
the second network structure comprises a first data center;
the third network structure comprises a second data center;
the fourth network structure comprises a first room of the first data center; and
the fifth network structure comprises a second room of the first data center.
